(19) United States
(12) Patent Application Publication
(10) Pub. No.: US 2024/0240825 A1
(43) Pub. Date: Jul. 18, 2024

(54) HIGH POWER PORTABLE RESERVOIR HEATER

(71) Applicant: Christopher Jackson Crawford, Carlsbad, CA (US)

(72) Inventor: Christopher Jackson Crawford, Carlsbad, CA (US)

(21) Appl. No.: 18/096,786

(22) Filed: Jan. 13, 2023

(51) Int. Cl. F24H 1/00; B60D 1/64; F24H 15/223

(52) U.S. Cl. CPC F24H 1/009; B60D 1/64; F24H 15/223; B60Q 1/0076

(57) ABSTRACT

A high power, portable reservoir heater provides a temperature-controlled water supply for the remote dispensing of liquids, such as water. An electrical heating element wired to a vehicle's electrical system provides to access the 20 Amp source for the heater, thereby delivering a high current source to an electrically-resistive, high power heating element that is immersed into a liquid reservoir to heat the contents. Specifically designed to work on 7-pin trailer receptacles, the heater includes a temperature probe which is maintained at a predetermined distance from the heating element, and a thermostat that allows a user to adjust the temperature of the liquid, usually water, being heated. The heater can be activated by turning on a vehicle's running lights or by an On/Off switch.

### PRIORITY CLAIM

This application claims priority to U.S. Provisional 63/266,821, filed Jan. 14, 2022.

### BACKGROUND OF THE INVENTION

The present invention is directed to electrical heating devices for heating liquids. The present invention is more particularly, though not exclusively, directed to a high power heating element used for heating liquids in portable liquid reservoirs. The present invention is most useful for providing a temperature controlled water supply for the remote dispensing of liquids, such as water.

### SUMMARY OF THE INVENTION

The high power portable reservoir heater of the present invention includes an electrical heating element that is in electrical communication with a vehicle to provide a high current source. When in use, a vehicle's high current source is connected to an electrically resistive high power heating element that is immersed into a liquid reservoir to heat the contents of the reservoir.

Historically, most vehicles have electrical systems that may have specific electrical connection ports, such as what was previously known as a cigarette lighter port, for allowing the periodic connection of accessories, such as personal electronics, radios, spotlights, etc. These traditional electrical ports, however, are often limited in the amount of current that they can provide. For instance, a typical cigarette lighter port (if they are even available in the vehicle) is limited to 10 amps which may be sufficient for some lower power uses, but is insufficient for uses requiring additional current capacities, such as heating elements.

Many vehicles, particularly vehicles that are used to tow trailers, are equipped with a 7-pin trailer receptable that is used to provide signals and power to the lighting and brake system of the trailer being towed. The 7-pin receptacles, and the 7-pin plugs that they receive, are a well-known standard in the industry and all have identical pin designations. This allows for the interchangeability between trailers and vehicles without regard to any particular electrical configuration. The 7-pin receptacles include electrical connections for various functions, including tail lights, left and right turn/brake lights, backup lights, a ground connection, a trailer brake signal, and an auxiliary power terminal. The standard current capacity for the auxiliary power terminal is 20 amps which is far greater than any other source of current from a vehicle unless a connection is made directly to the battery itself which is both dangerous and inconvenient.

The high power portable reservoir heater of the present invention includes an electrical power plug that connects to a vehicle trailer receptacle to access the high current 20 amp source for electrical power for the heater. The high power portable reservoir heater is designed to work with all vehicles having a 7-pin trailer receptacle including those with safety circuits intended to prevent the flow of electricity unless a trailer is attached.

### BRIEF DESCRIPTION OF THE FIGURES

FIG. 1 shows first embodiment of a high power portable reservoir heater of the present invention having an electrical connection leading to a heating element shaped to include an angled portion that facilitates the more distributed heating of a liquid in a reservoir, and having a corresponding temperature probe to sense the temperature of the liquid being heated;

FIG. 2 shows a second embodiment of a high power portable reservoir heater of the present invention having a tubular heating element having a threaded region for threadably inserting the element into a reservoir for immersion into a liquid, and with an electrical connection leading to a supply cable for connection to the 7-pin power plug:

FIG. 3 is a diagram showing the standard pin designations of the 7-pin trailer connections and their respective signal types, such as brake lights, running lights, backup lights, brake signals, ground connections, and auxiliary power connection; and

FIG. 4 is a schematic diagram of the high power portable reservoir heater of the present invention showing the 7-pin trailer plug in electrical connection with a heating element, in which several pins of the 7-pin receptable are used to provide high current power and a relay control signal to drive and control the heating element.

### DETAILED DESCRIPTION OF THE INVENTION

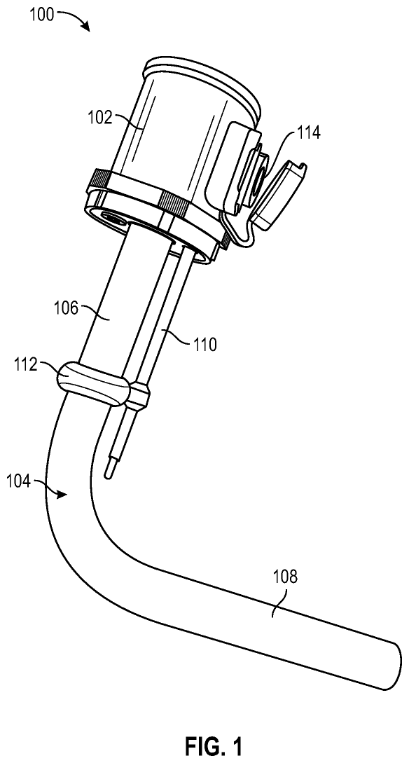

Referring initially to FIG. 1, a first embodiment of a high power portable reservoir heater of the present invention is shown and designated 100. High power portable reservoir heater 100 includes an electrical connector 102 that is designed to establish electrical connection with a 7-pin trailer plug (not shown this Figure). Electrical connections from connector 102 are made with the internal resistive heating component (now shown) in heating element 104 such that when current is passed through connector 102 to heating element 104, the element is heated.

As shown in this Figure, heating element 104 is formed with a first portion 106 extending from connector 102 and a second portion 108 that is at an angle from first portion 106. This configuration is useful for circumstances where the depth of the reservoir being heated is insufficient to support a straight heating element, and also provides for a more distributed heating of a liquid in a reservoir as the heated liquid rises away from the angled portion 108 of the heating element 104, instead of simply rising alongside the heating element which results in the liquid being non-uniformly heated or prematurely triggering a thermostat to turn off the heater.

High power portable reservoir heater 100 includes a corresponding temperature probe 110 to sense the temperature of the liquid being heated. The probe 110 is maintained at a predetermined distance from heating element 104 using bracket 112. Bracket 112, in a preferred embodiment, is made from a heat insulative material such that no heat is directly transmitted from heating element 104 to probe 110. Additionally, probe 110 extends from connector 102 which may also include a thermostat that allows for the adjustment of the temperature of the liquid being heated, or an electrical connection to probe 110 may be provided by port 114 for connection to an external thermostat.

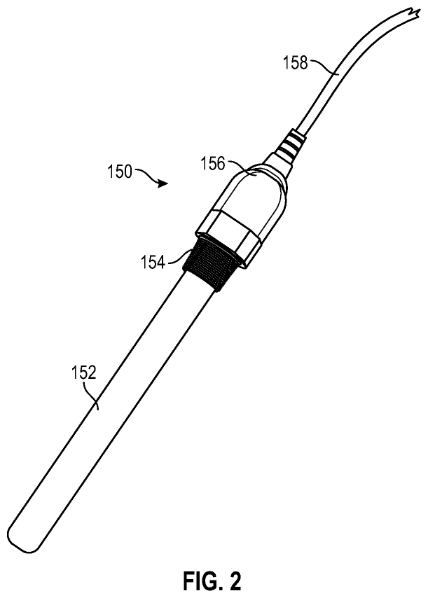

FIG. 2 shows an alternative embodiment of the high power portable reservoir heater of the present invention and is generally designated 150. High power portable reservoir heater 150 includes a tubular heating element 152 having a threaded region 154 for threadably inserting the element into a reservoir for immersion into a liquid. An electrical connection 156 leads to a supply cable 158 for connection to the 7-pin power plug. Supply cable 158 may also be connected to an external thermostat for controlling the temperature of the heating element 152.

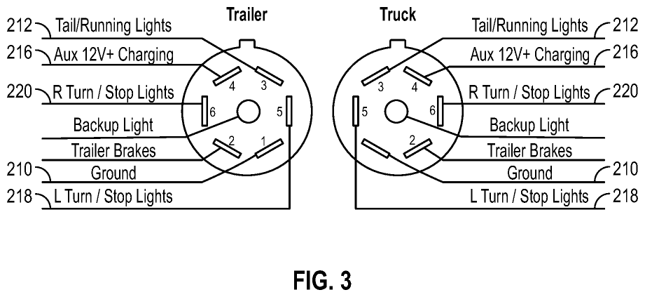

As stated above, the 7-pin receptacles, and the 7-pin plugs that they receive, are a well-known standard in the industry and all have identical pin designations. FIG. 3 is a diagram showing the standard pin designations of the 7-pin trailer connections and their respective signal types, such as tail lights 212, left and right turn/brake lights 218 and 220, backup lights, a ground connection 210, a trailer brake signal to trigger a trailer's electrical braking system, and an auxiliary power terminal 216. From this Figure, it can be seen that the 4th pin 216 is designated as a “Aux 12V+ Charging” pin, and generally can provide up to 20 amps.

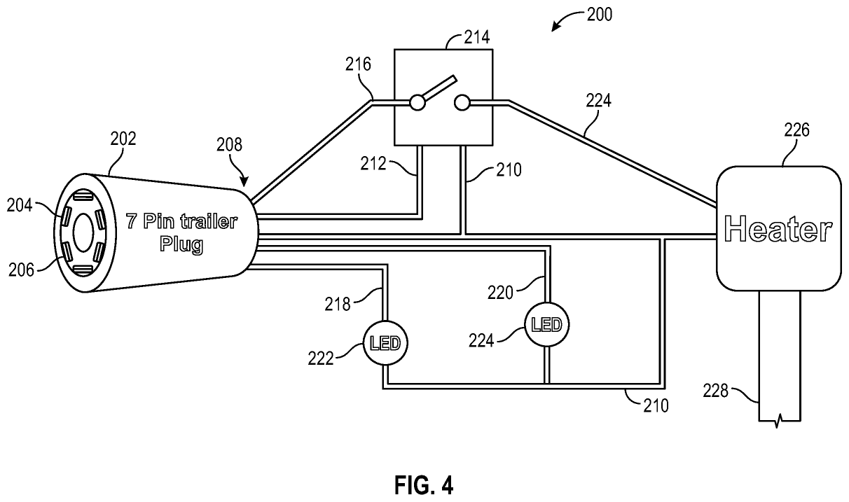

Referring now to FIG. 4, a schematic diagram of the high power portable reservoir heater 100 of the present invention is shown. 7-pin trailer plug 202 includes a variety of pins 204 . . . 206 as generally described above, with a number of electrical connections 208 extending from plug 202. The electrical systems that use the vehicle trailer connections illustrated herein is a negative ground system, and ground connection 210 extends throughout the high power portable reservoir heater 100.

In order to provide the heating element 228 of heater 226 with the high current supply that is required, the auxiliary pin 216 is connected to the input of a high current relay 214. The output terminal 224 of the relay 214 is connected to the input of heater 226. The On/Off control of the relay 216 is accomplished by connecting the relay power lead to running light terminal 212. In this configuration, the high power portable reservoir heater 100 can be turned on and off simply by switching the running lights on and off on the vehicle. Alternatively, the relay power lead may be attached through a switch (not shown) to the auxiliary pin 216 and relay 214 may be controlled by turning the switch On and Off.

While each vehicle trailer plug has the same universal shape and the same pin designations, a vehicle manufacturer may have separate controls for the particular operation of the trailer signals. For instance, a Ford vehicle will not send power to the trailer receptacle unless it senses that a trailer with brake lights is connected. To accommodate this nuance, the high power portable reservoir heater may include a pair of light emitting diodes (LEDs) 222 and 224 connected respectively to the left stop light terminal 218 and right stop light terminal 220 to simulate the presence of brake lights in the circuit. As a result of LEDs 222 and 224, the high power portable reservoir heater of the present invention will work with vehicles that either have, or do not have, the Ford-type sensing technology.

The heater 226 as described herein may include a number of alternative embodiments which have features that provide a simple, easy to use solution for heating liquids in a changing environment. For instance, in a preferred embodiment, heater 226 may include a water level sensor that shuts off the heater 226 when the water level is too low. An alternative embodiment of heater 226 includes a built-in thermostat that automatically controls the heater power thus heating the water to a comfortable temperature and not overheating the water. Another alternative embodiment includes a built-in thermal fuse that prevents the heater from overheating in the event that the thermostat fails. Yet another alternative embodiment includes a built-in LED display that shows the system status. For instance, the LED display shows whether the system is “Heating”, has a “Low Water” condition, is “Ready” to heat, or has “Over-Heated”.

The high power portable reservoir heater of the present invention is intended for use in outdoor, rugged and remote locations, and as such, all components are made to be weather resistant or water proof. The circuitry depicted in FIG. 4 is sealed and contained in a weather resistant housing to avoid risk from environmental hazards, such as dust, rain and ice.

The electrical connections that have been outlined above obtain power from connection to a vehicle's trailer receptacle. However, it is also contemplated herein that the high power portable reservoir heater is configured to obtain power from a standard cigarette lighter port, although at a lesser current level due to the vehicle's wiring system limitations. Additionally, alternative embodiments have a 120 v AC plug allowing the high power portable reservoir heater of the present invention to be plugged into a vehicle equipped with such power outlets, or alternatively into a standard wall outlet. The 120 v AC plug includes a Ground Fault Circuit Interrupt (GFCI) to protect users from electric shock.

What I claim is:

1. An electrical heater for the remote heating of liquids in portable reservoirs, where the electrical heater comprises an electrical heating element, a reservoir, and an electrical connection to an electrical system of a vehicle, where the electrical heating element heats a liquid contained in the reservoir.

2. The electrical heater of claim 1, where the heating element has a tubular shape.

3. The electrical heater of claim 1, where the electrical connection is to a 7-pin trailer receptacle.

4. The electrical heater of claim 3, where the electrical connection has an internal resistive heating component.

5. The electrical heater of claim 4, where the electrical connection is to a DC power supply.

6. The electrical heater of claim 5, where the electrical heater additionally comprises a temperature probe, where the temperature probe is maintained at a predetermined distance from the heating element.

7. The electrical heater of claim 6, where the temperature problem additionally comprises a connector to a thermostat, where the thermostat is adjustable such that a liquid temperature is adjustable by the user.

8. The electrical heater of claim 1, where the electrical heater can be activated by turning on running lights on the vehicle.

9. The electrical heater of claim 1, where the electrical heater can be activated by turning on an On-Off switch.

10. The electrical heater of claim 1, where the electrical heater additionally comprises an AC power supply with a Ground Fault Circuit Interrupt (GFCI).
